(19) United States
(12) Patent Application Publication
(10) Pub. No.: US 2023/0267552 A1
(43) Pub. Date: Aug. 24, 2023

(54) SYSTEM AND METHOD FOR THE MANAGEMENT OF CONTRACTUAL LIABILITY RISK TRANSFER

(71) Applicant: RESOLVED RISK LLC, New York, NY (US)

(72) Inventor: DANIEL WAGNER LONDON, New York, NY (US)

(21) Appl. No.: 18/114,036

(22) Filed: Feb. 24, 2023

Related U.S. Application Data
(60) Provisional application No. 63/313,562, filed on Feb. 24, 2022.

(51) Int. Cl. G06Q 40/08

(52) U.S. Cl. CPC G06Q 40/08

(57) ABSTRACT

The method and system is for the management of contractual liability risk transfer via the Internet consisting a the following: a method and system for (a) verification of vendor compliance with contractual insurance purchasing obligations, (b) transmitting notice of claims and/or potential claims to a client that has issued a policy to said vendor and (c) creation of contractual liability risk transfer obligations between an upstream party and a non-party vendor consistent with the liability risk transfer requirements specified in the construction agreement and/or insurance policy issued to the upstream party by the client.

### CROSS-REFERENCE TO RELATED APPLICATIONS

This application claims priority to U.S. Provisional Application Ser. No. 63/313,562, filed Feb. 24, 2022, the entire contents of which are hereby incorporated by reference in their entirety.

### BACKGROUND

Manual analysis of insurance policies purchased by trade contractors cannot be performed before trades begin work. The manual review process is time intensive and one expert can only review one insurance policy at a time. Therefore, it is not possible to review many insurance policies all at once as is the case when an owner or general contractor hires many vendors for a single job. The manual review process is expensive and the cost of review can easily exceed the premium for a single policy sold to an owner or general contractor. The manual process is subject to human error and inconsistency.

As a result, owners, general contractors and/or their vendors are left holding the bag when they (a) do not verify additional insured coverage purchased by vendors, (b) fail to capture notice of claim information for policies purchased by vendors, and (c) fail to enter into vendor contracts that comply with the risk transfer requirements specified in their construction agreements and/or policies.

To protect themselves from liability for a vendors' work, owners and general contractors (“upstream parties”) require vendors to buy insurance that provides coverage to upstream parties as additional insureds. Vendors show compliance with this obligation by giving upstream parties a note from their insurance broker, called a certificate of insurance. Upstream parties rely on the certificate of insurance as evidence that the vendor bought the required insurance. But these notes are incomplete, they don't track policy expirations, and the note doesn't obligate a client to provide the coverage as described.

### SUMMARY

A method and system for the management of contractual liability risk transfer via the Internet consisting of the following: a method and system for (a) verification of vendor compliance with contractual insurance purchasing obligations, (b) transmitting notice of claims and/or potential claims to a client that has issued a policy to said vendor and (c) creation of contractual liability risk transfer obligations between an upstream party and a non-party vendor consistent with the liability risk transfer requirements specified in the construction agreement and/or insurance policy issued to the upstream party by the client. As used here, client is any owner, developer, general contractor, carrier, managing general agent, third party administrator, insurance producer or other system end user.

The present invention discloses a digital insurance product focused on the liability exposure of owners, developers and general contractors.

In a first aspect of the present invention, disclosed are systems and methods for selling commercial general liability insurance directly to developers and general contractors as a managing general agency. A managing general agent is an insurance producer authorized to underwrite and sell insurance on behalf of an existing client. The managing general agent keeps a percentage of premium but is not liable for losses. The insurance carrier takes a larger percentage of premium but retains liability for losses.

The policies incorporate a web-based risk management platform that validates transfer of liability risk from policyholders to their vendors. The risk transfer platform (a) increases liability risk transfer to policies purchased by vendors and, inter alia, decreases the number of claims paid by the policies, (h) captures information directly from vendor policies and automates the notice of claim process to increase speed of risk transfer and avoid errors, and (c) creates a workflow for the execution of risk transfer agreements to avoid instances in which policyholders fail to comply with policy specifications pertaining to risk transfer.

In another embodiment of the present invention, disclosed is a web-based risk management platform incorporated into policies sold by clients to their customers. Evaluations of vendor policies are used to recommend supplemental coverage where vendor policies fail to meet contractual requirements.

In another embodiment of the present invention, disclosed is a web-based risk management platform used by an owner, developer or general contractor without incorporation into a specific insurance policy or product.

In some embodiments, policies that utilize the present invention are priced retrospectively/dynamically on the basis of information collected in the system and the likelihood of successful risk transfer to vendors. Factors in retrospective/dynamic pricing include (i) size of construction contracts undertaken by policyholder, (ii) number of vendors working across projects, (iii) quality of vendors' policies viz. likelihood of successful risk transfer based on relative compliance with requirements, (iv) relative risk of loss based on loss history of vendors across all projects monitored in the system.

### BRIEF DESCRIPTION OF THE DRAWINGS

FIG. 1 depicts an example template screen.

FIGS. 2-7 depict screens showing how a new template is created.

FIG. 8 depicts an example client screen.

FIGS. 9-13 depict screens showing how new clients are created.

FIGS. 14-16 depict screens showing how jobs are created.

FIGS. 17-20 depict screens showing how vendors are added.

FIGS. 21-23 depict flowcharts showing how insurance policies, contracts, etc. are parsed and compared to determine compliance with client requirements.

FIGS. 24-25 depict screens showing how a claim is submitted.

FIGS. 26-37 depict screens showing how new vendors are onboarded.

### DETAILED DESCRIPTION

The system makes it quick and easy to verify additional insured coverage and track compliance through the life of a project. Clients for upstream parties require policyholders to use the system as part of a risk management program specifying indemnity and insurance purchase requirements for construction trades. Policyholders create jobs in the system and invite vendors to register, execute client-approved risk transfer agreements and upload their policies for verification.

In a few seconds, coverage is verified and deficiencies are noted. Stakeholders are informed of the results. Vendors' policy information is captured. The present invention tracks policy expiration dates, remind vendors to re-submit when they renew coverage, and warn stakeholders if a policy expires without a verified replacement. If accidents happen, stakeholders can put any vendors' carrier on notice at the click of a button because notice information is captured when policies are reviewed and updated in our master database.

Method for Verification of Vendor Compliance with Contractual Insurance Purchasing Obligations

Policies issued through Resolved Risk (or a participating client) (‘RR Policy’) require the Resolved Risk policyholder (‘RR Policyholder’) to make use of the system when hiring a vendor for work at a project covered by the RR Policy.

The system consists of a consumer facing web application containing a Customer Interface and a web application or series of web applications for data processing, as described below. Interaction with the back-end web applications is accomplished through user interface(s) consisting of a Labeling Interface and a Parser interface. The parser interface is substantially similar to the labeling interface but includes editing functions.

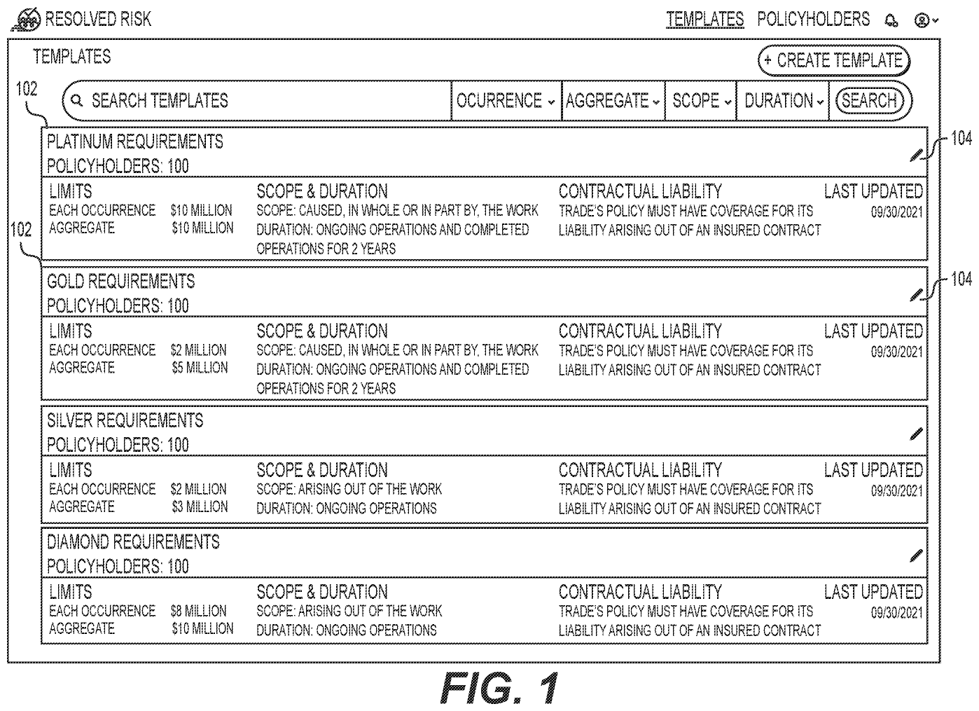

Risk Transfer Requirements for each RR Policy are stored in the client requirement database. There is a defined set of Risk Transfer Requirements and each RR Policy is assigned to one of the defined sets. The Risk Transfer Requirements are referred to herein as ‘templates.’ An example template homepage detailing the different requirements of each template is depicted in FIG. 1, As shown, clients can create a variety of different templates 100 with different requirements such as platinum, gold, silver, diamond, etc. to distinguish between the templates. For example, the depicted platinum requirements have limits of 10 million dollars for each occurrence (e.g., worksite accident) as well as an aggregate limit of 10 million dollars. In contrast, the gold requirements limit the payout to each occurrence to 2 million dollars, with an aggregate limit of 5 million dollars. Each client can create their own templates for different purposes. Any of the template requirements can be edited by the client by selecting the “edit” symbol 104 next to each template description.

Template Creation

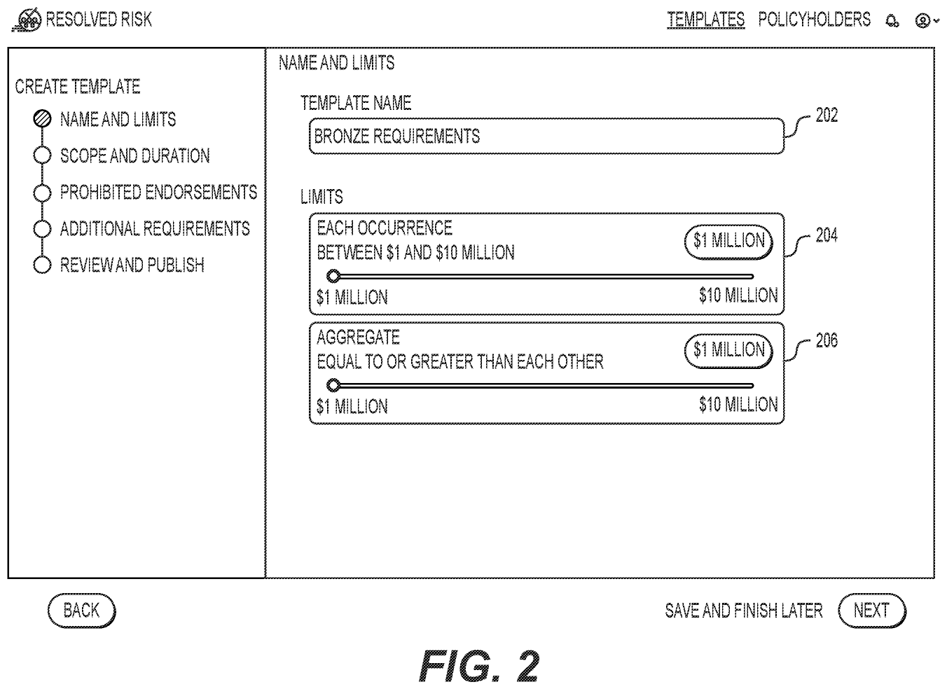

To create a template, client are provided a graphical user interface (GUI). FIGS. 2-7 depict a series of screens used by a client to create a new “Bronze” template. The workflow for creating a template generally comprises gathering information such as name and limits, scope and duration, prohibited endorsements, and any additional requirements. As depicted in FIG. 2, the client assigns a name to the template in the template name field 202. Here, the template has been named “Bronze Requirements.” The client must also select limits for each occurrence and aggregate. Preferably, the limits are set by using sliders 204 and 206 for ease of use. However, other interfaces such as a text box may be utilized if the amount needs to be more exact than is possible using a slider.

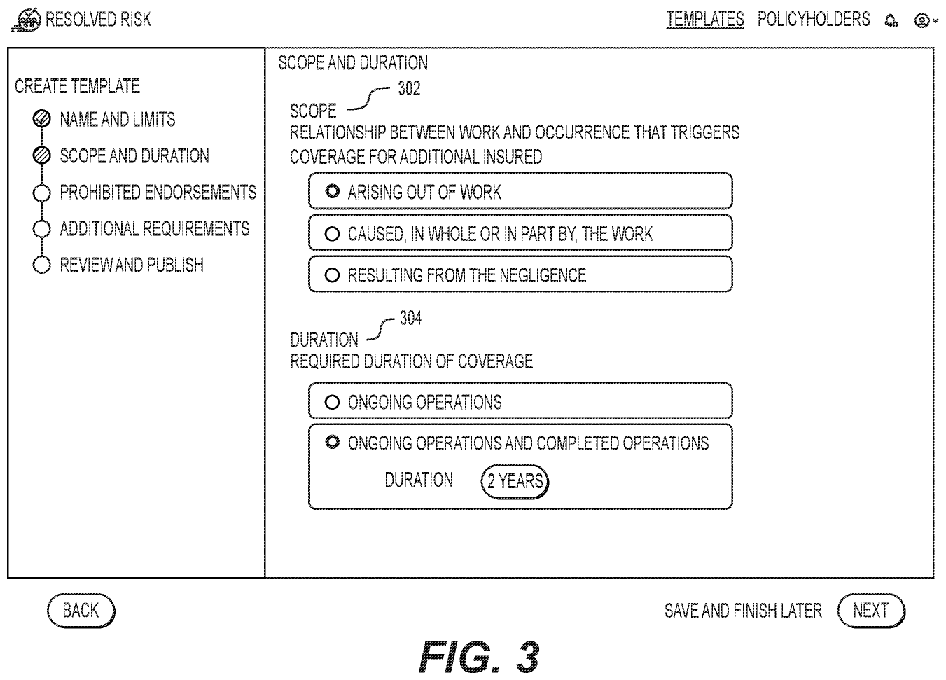

Next, the client must enter the scope and duration for the template as depicted in FIG. 3. The scope defines the relationship that triggers coverage as an additional insured and the duration specifies the time duration of completed operations coverage afforded by the policy (e.g., unlimited, 2 years, etc.). In the described example, the client can choose from options for the relationship that triggers coverage as an additional insured such as arising out of the work, caused by the work, or resulting from negligence for the scope selection 302. It should be obvious to one of ordinary skill in the art that other options for the scope can be added or deleted as needed. If the completed operations coverage afforded by the policy is meant to have an expiration, the client can specify a duration of the coverage in duration selection 304.

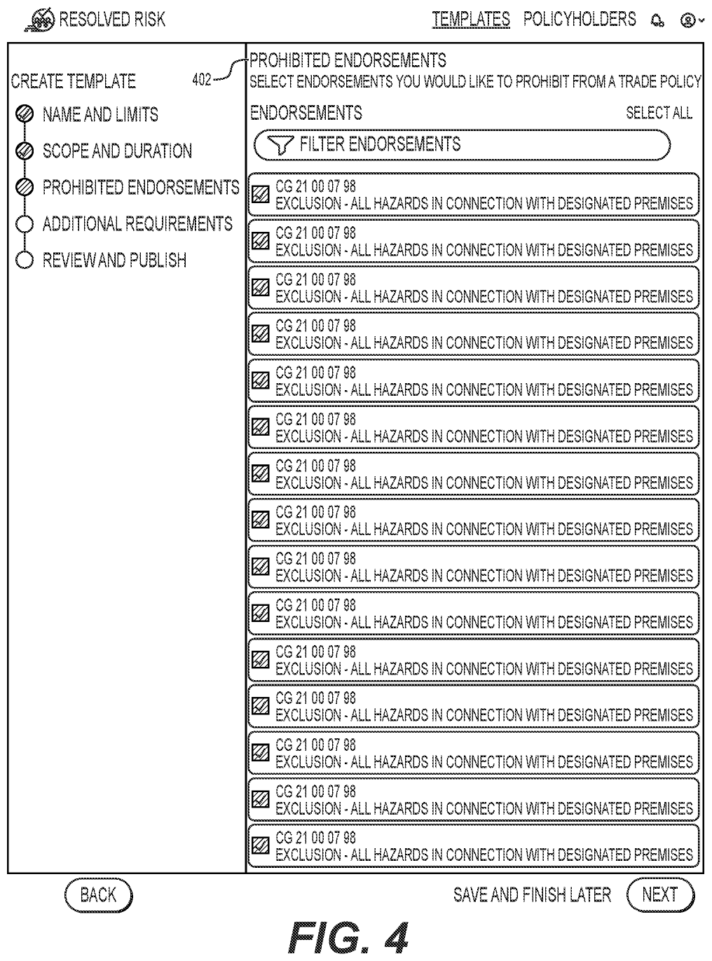

The client may also select prohibited endorsements from a list of prohibited endorsements 402 as depicted in FIG. 4. The prohibited endorsements specify exclusions from the template. In the depicted example, the exclusions are all identified by their form number such as “CG 21 00 07 98” and others.

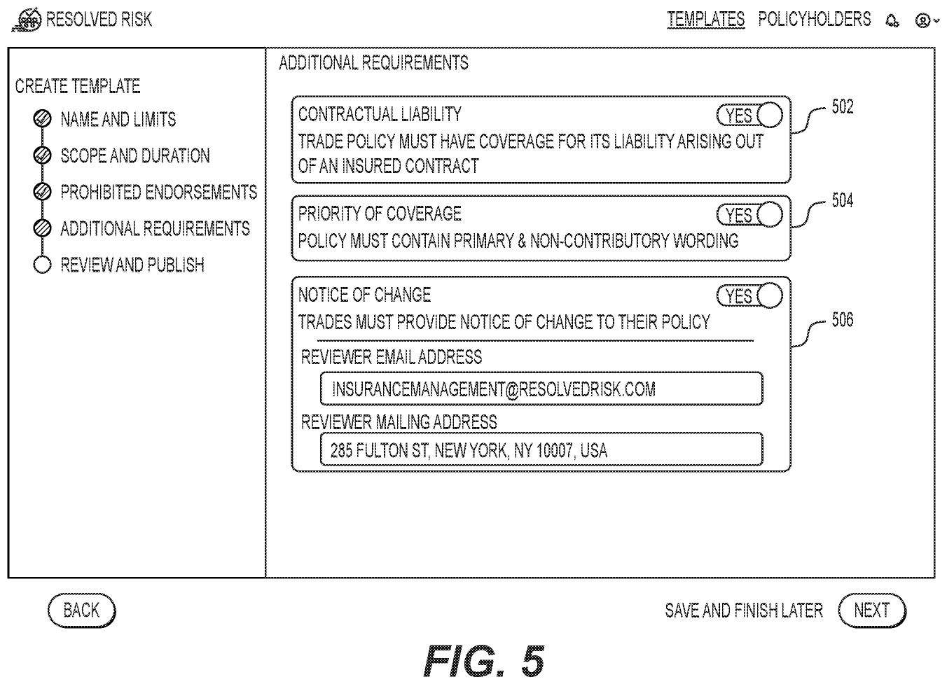

The final requirements for creating a template are to gather any additional requirements from the client as depicted in FIG. 5. These may include, but are not limited to, contractual liability selection 502, priority of coverage selection 504, and notice of change selection 506. If a notice of change is required, the GUI has fields that allow the client to designate a reviewer email and a reviewer address to which any changes are sent for approval.

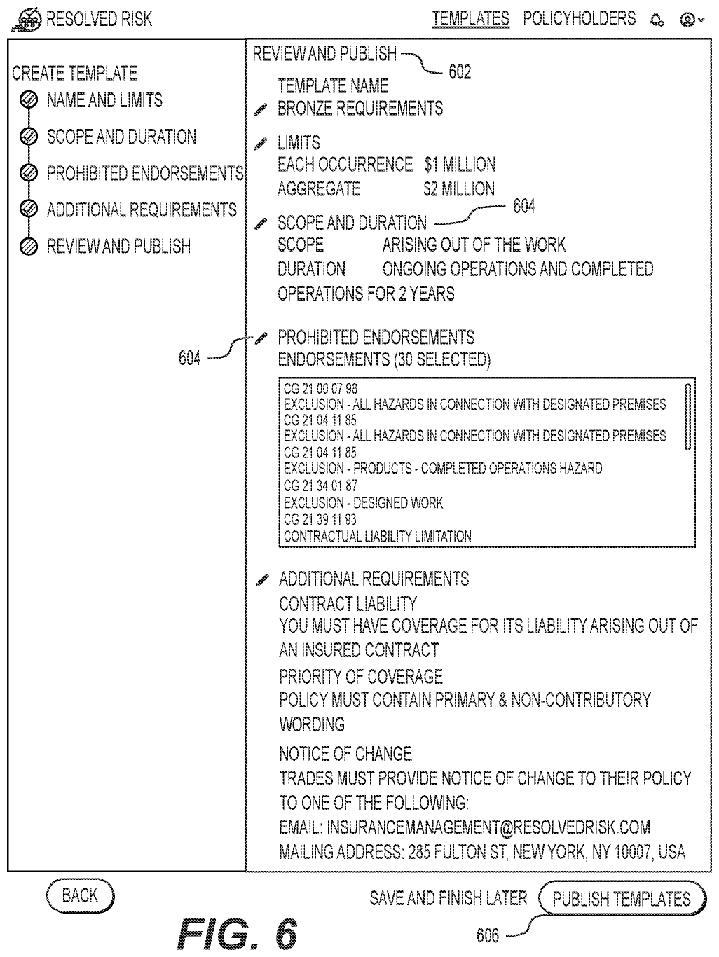

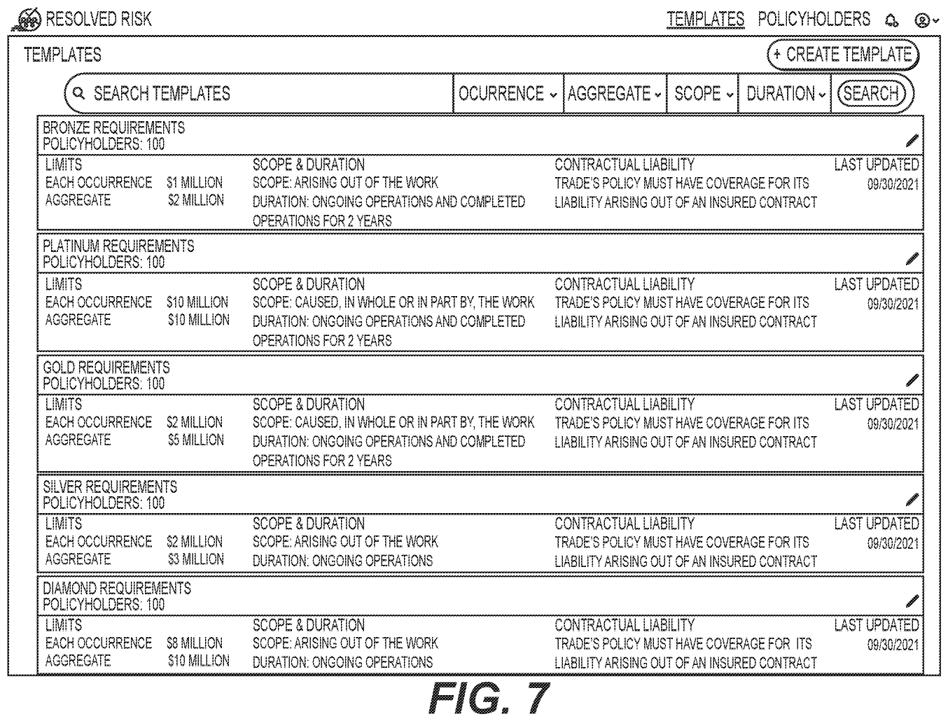

The client can review all of the template creation answers on review and publish screen 602 as depicted in FIG. 6. As shown, this screen 602 provides a summary of all the selections that the client made during the creation process. The client can edit any of the selections by selecting the edit symbol 604 next to each section header. The client also has the option of saving the template for later editing or publishing the template. Once the publish template selection 606 is selected, the newly created “Bronze Requirements” template is added to the templates homepage (similar to FIG. 1) as depicted in FIG. 7.

Policyholder Creation

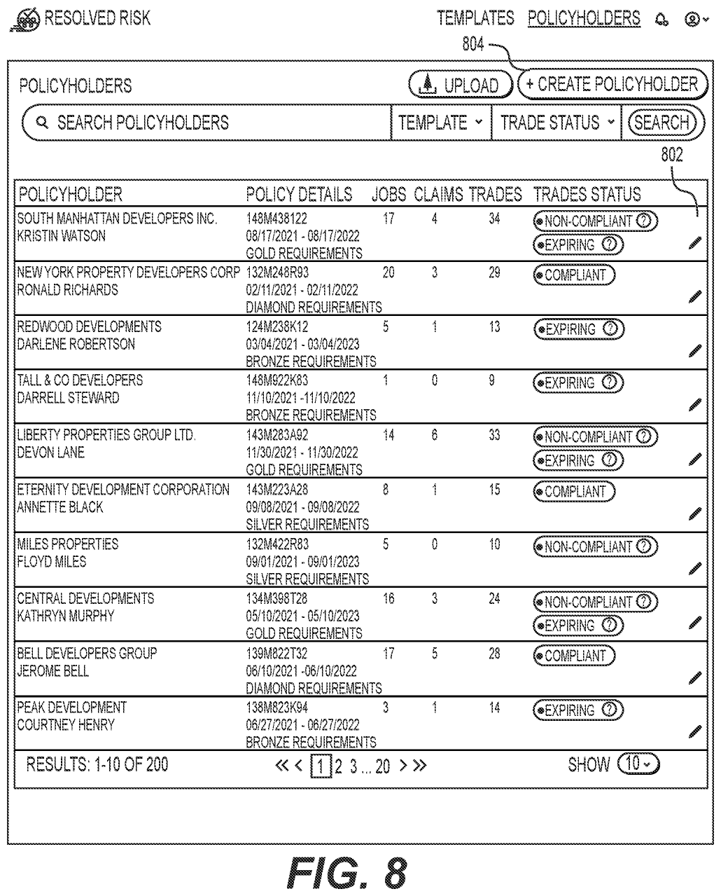

FIG. 8 depicts an example screen showing all policyholders that have been created or added by the client. This screen provides the client with an overview of all policyholders as well as basic statistics such as number of jobs, claims, vendors, vendor status, etc. Any of the policyholders information can be edited by the client by selecting the edit symbols 802. To add a new policyholder, the client selected the create policyholder button 804.

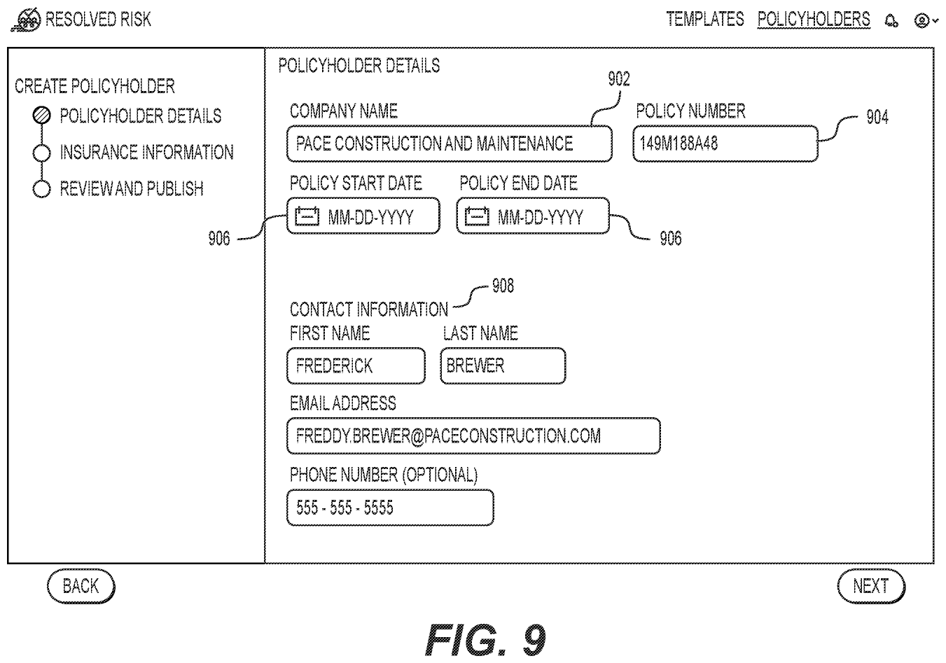

FIGS. 9-12 depict the user interface used to create a new policyholder. As depicted in FIG. 9, the client adds a name to company name field 902 used to identify the policyholder and a policy number 904. The client must add a policy start date and a policy end date. Preferably, the user can select calendar selections 906 which allow the client to select the date from a drop down calendar. However, the user may also manually enter the dates as is known in the art. Each policyholder also has a primary contact which is added to contact information 908.

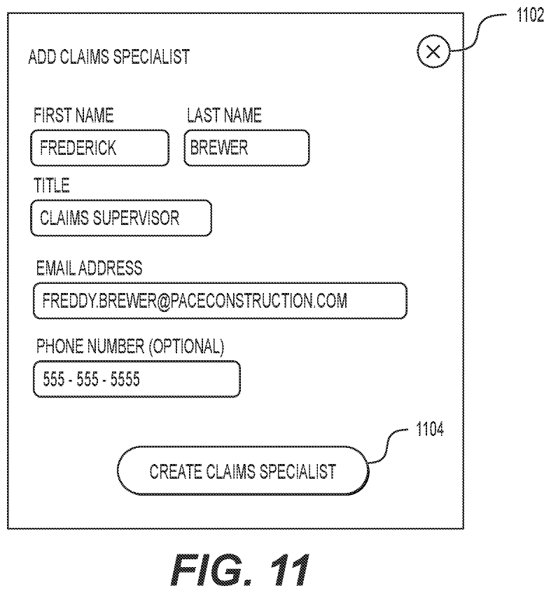

Next, the client must enter insurance information for the policy. A claim specialist and contact information for the claim specialist must be identified. The client can select the claim specialists from drop down list 1002 which will then automatically populate contact information field 1004. The client can also choose to add a claim specialist from drop down list 1002. If the client selects to add a claim specialist, the client is directed to an add claim specialist window or screen 1102 as depicted in FIG. 11. On the add claim specialist screen 1102, the client must enter information such as name, title, email address, and phone number. Once the relevant information has been entered, the client can select the create claims specialist selection 1104 to enter the claims specialist into the system.

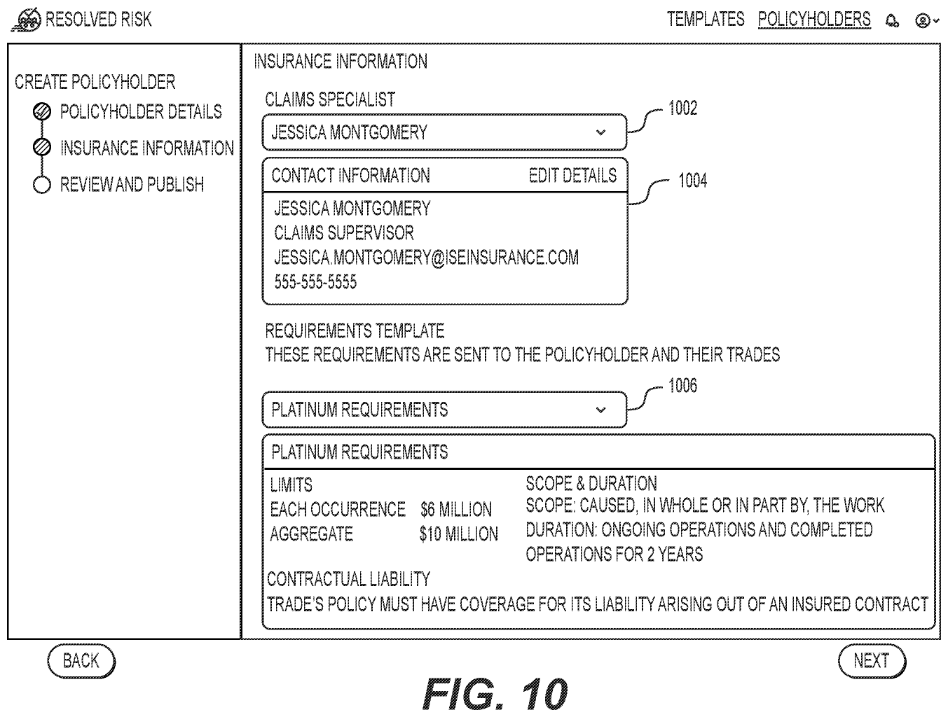

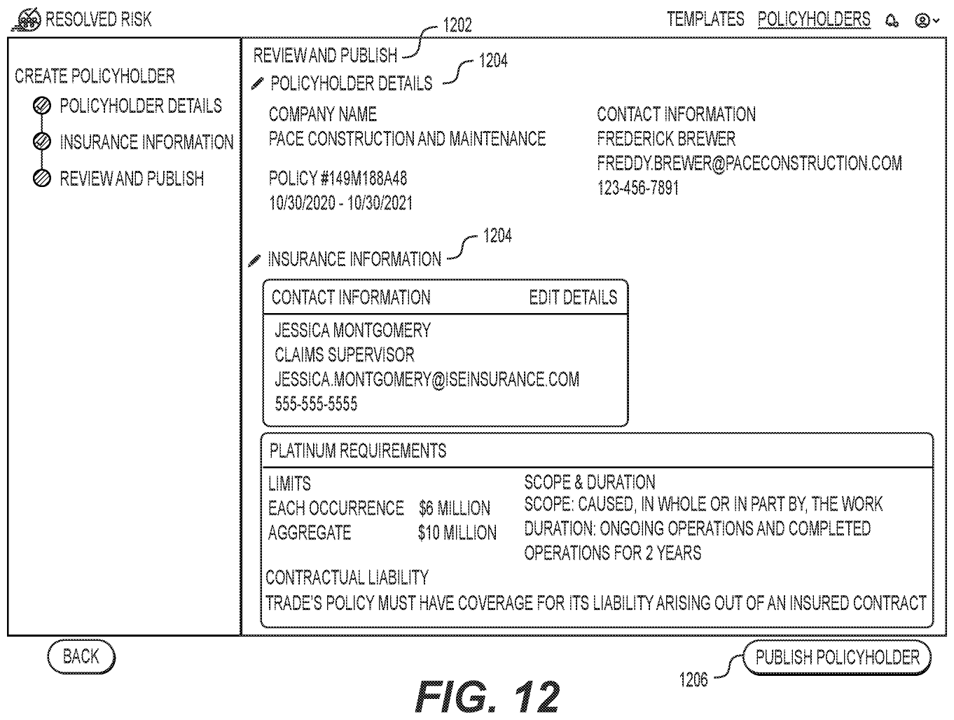

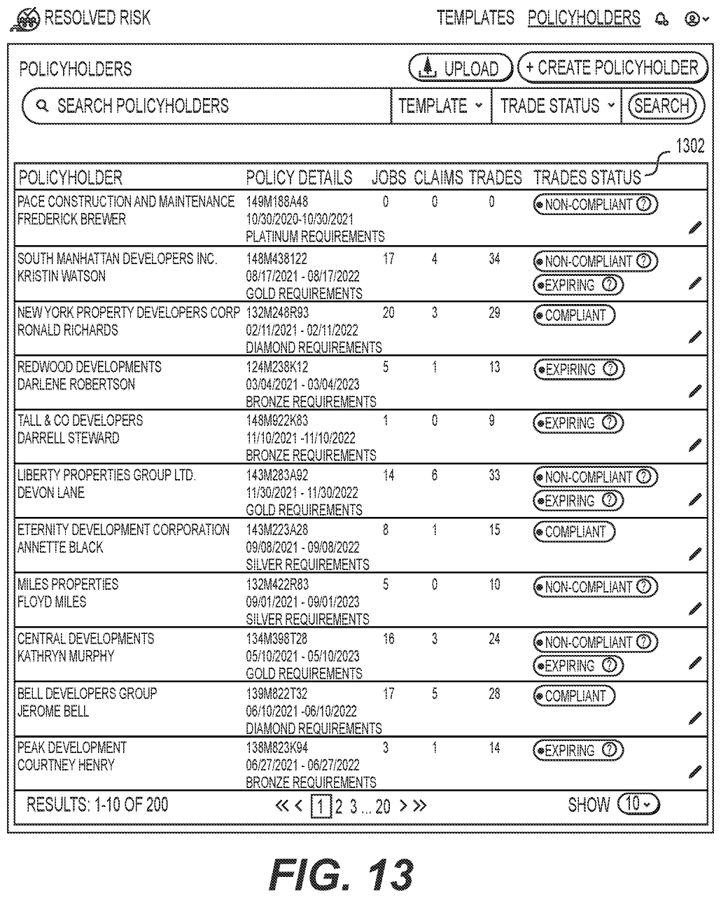

Referring back to FIG. 10, the client must also select a requirements template for the policyholder and their vendors from drop down list 1006. The client can select any of the templates that have been created by the client as shown in FIGS. 1-7. The client is provide a final review screen 1202 once all of the policyholder information has been selected as shown in FIG. 12. The client can select any of the edit symbols 1204 to update the relevant sections. Once all of the information has been reviewed by the client, the client selects the publish policyholder selection 1206 to add the policyholder to the policyholder home screen as depicted in FIG. 13. The policyholder home screen also depicts the current vendor status 1302 of each policyholder which may be compliant, non-compliant, expiring, expired, etc.

Job Creation

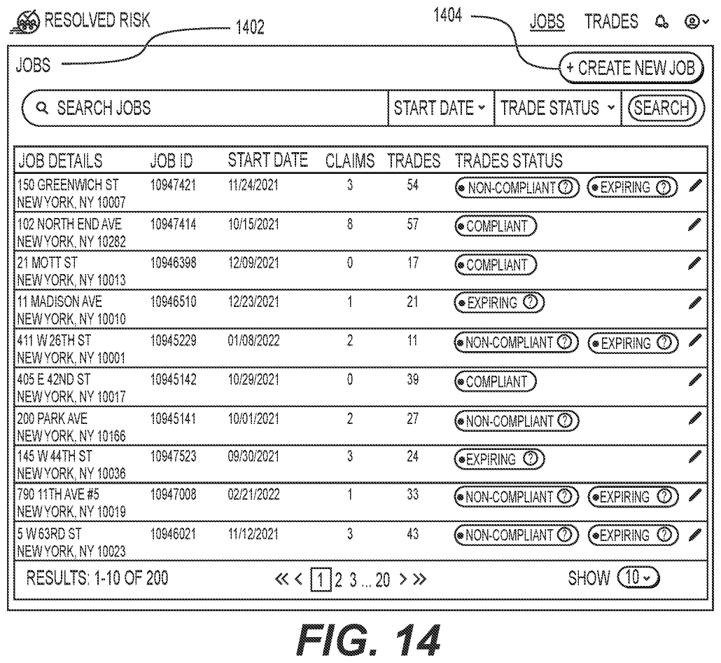

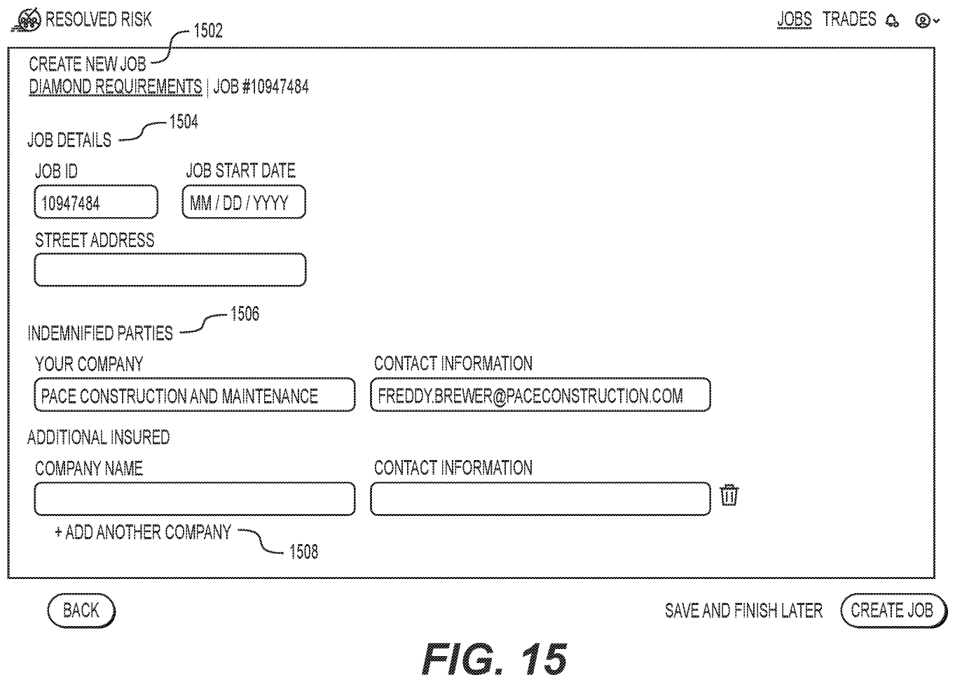

RR Policyholders use the system of the present invention create jobs in the system and invite vendors to register, execute client-approved risk transfer agreements and upload their policies for verification (‘Vendor Policy’) against the Risk Transfer Requirements stored in the client requirement database. The workflow for the creation of a job is depicted in FIGS. 14-16. FIG. 14 depicts job screen 1402 which lists all jobs created by the client. Each job may be assigned an address, job ID, start date, etc. In addition, the job screen 1402 also depicts information about the job such as number of claims filed, vendors, and current vendor status. To create a new job, the client first selects create new job selection 1404. This directs the client to a job creation screen 1502 on which the job details may be entered. The client may select a template for the job to specify the requirements. In the depicted example, diamond requirements has been selected for job 10947484.

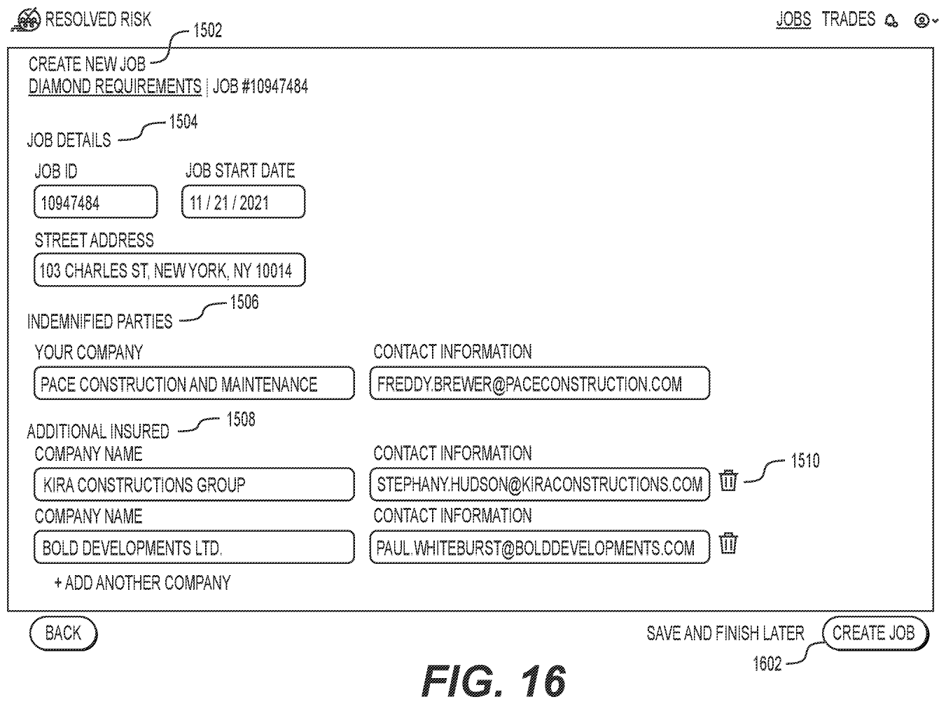

The client enters the job details in job details section 1504. This allows the client to specify a job ID, job start address, and a street address for the ob. Any indemnified parties may be added in indemnified parties section 1506. The client may also add any insured companies to the job using the additional insured selection 1508. The client can select insured parties from previous vendors that have already been added. For example, as shown in FIG. 16, the client has added. Kira Construction Group and Bold Developments Ltd. to the job. Any of these selections can be removed by selecting the delete icon 1510 associated with each company. To finally create the job, the client then selects the create job selection 1602.

Vendor Add

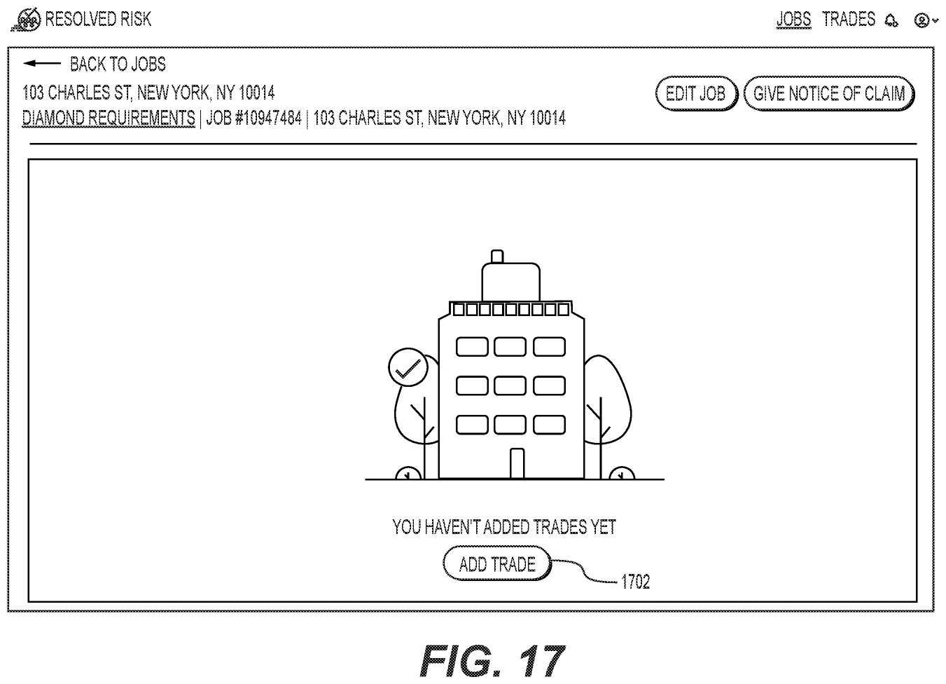

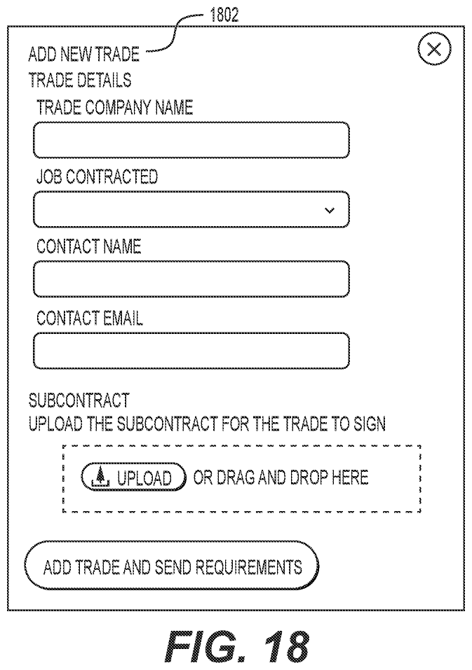

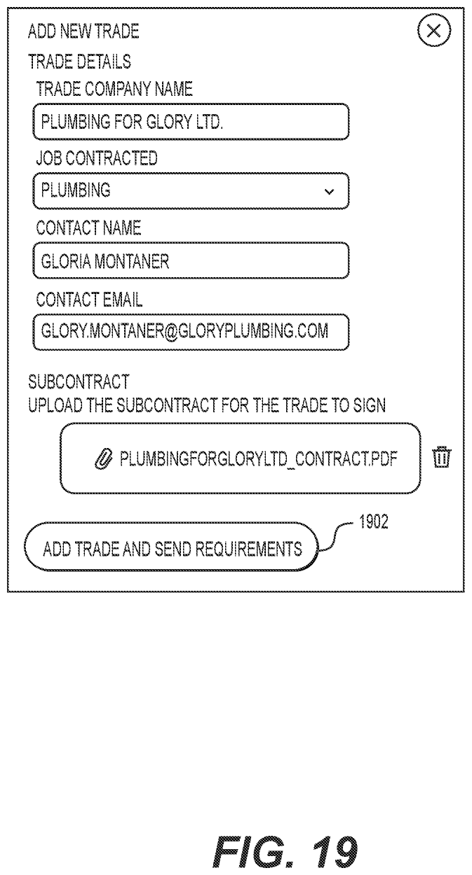

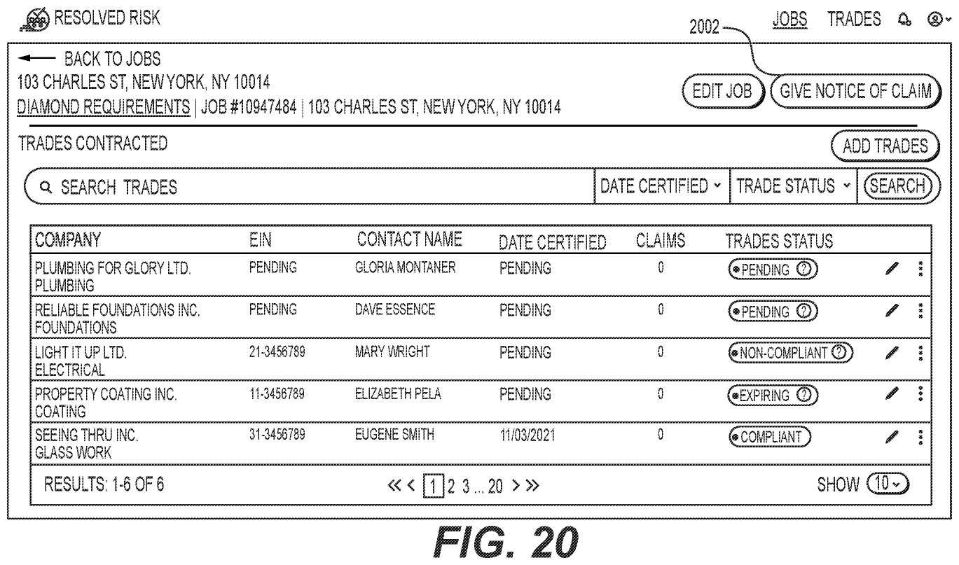

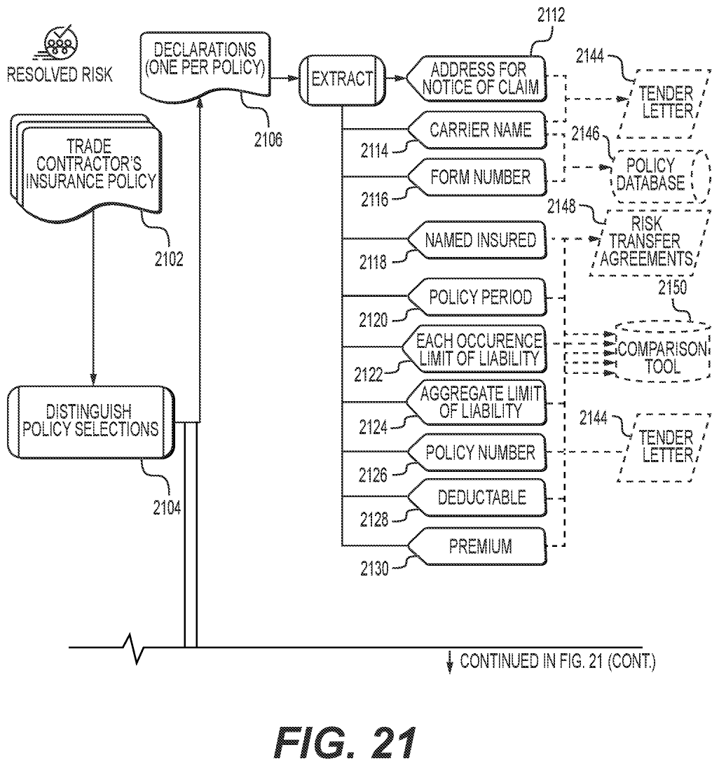

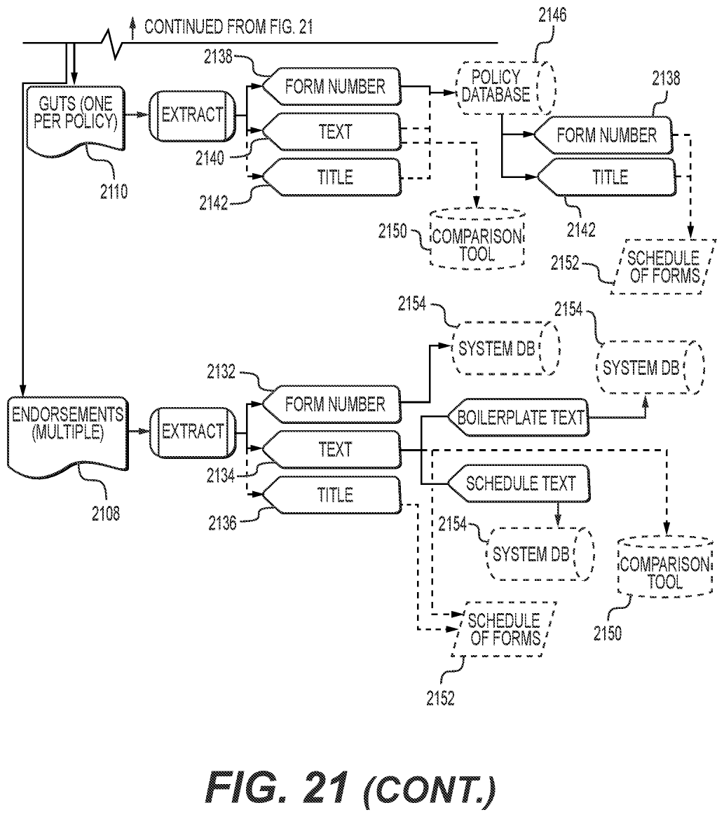

After a job has been created, any insured vendors (e.g., from additional insured selection 1508) are sent a message and invited to submit their information using the platform as depicted in FIG. 17. If the client selects the add vendor selection 1702, they are directed to add new vendor screen 180 as depicted in FIG. 19. Here the client may manually enter the vendor details. Alternatively, the client may upload a contract in any known format (e.g., PDF, JPG, etc). If the vendor chooses to upload a contract, the contract is converted to a machine readable format and parsed using the steps depicted in FIG. 21. Once the client verifies that all of the vendor information is correct, the user selects add vendor selection 1902. The new vendor is then added to the vendor listing as depicted in FIG. 20.

Document Parsing Workflows

The steps used for parsing extracted information from an uploaded vendor contract or insurance policy as depicted in FIG. 21. First, the vendor's insurance policy (or any insurance policy) is uploaded to the parsing engine in step 2102. The various section of the policy are then identified in step 2104. The full text of the document is analyzed with heuristic functions including keyword, text block and pattern matching. The results of the heuristic analysis are applied in a defined order of precedence to divide the single document into sections consisting of declarations 2106, endorsements 2108, and coverage forms 2110.

Once the various sections have been identified in step 2104, the content of each section can separately be analyzed, extracted, and stored. For declarations 2106, defined values may include address for notice of claims 2112, client name or client group name 2114, form number 2116, name of insured 2118, policy period 2120, occurrence limit 2122, limits of liability 2124, policy number 2126, deductible 2128, and premium 2130.

For endorsements, these defined values may include the defined values used for declarations as well as form number 2132, scheduled text entries 2134, and title 2136. For coverage forms, these values include form number 2138, scheduled text entries 2140, and title 2142.

In some embodiments, the extracted information can be used to autofill a boilerplate tender letter 2144 or risk transfer agreements 2148. The client name 2114 and form number 2116 can be stored, together or separately, in policy database 2146 along with other previously extracted information. Comparison tool 2150 can be utilized to determine if any of the extracted information matches with previously extracted information stored in any database, such as policy database 2146. If any new entries are detected, they can be added to the relevant database such as form database 2152 or system database 2154.

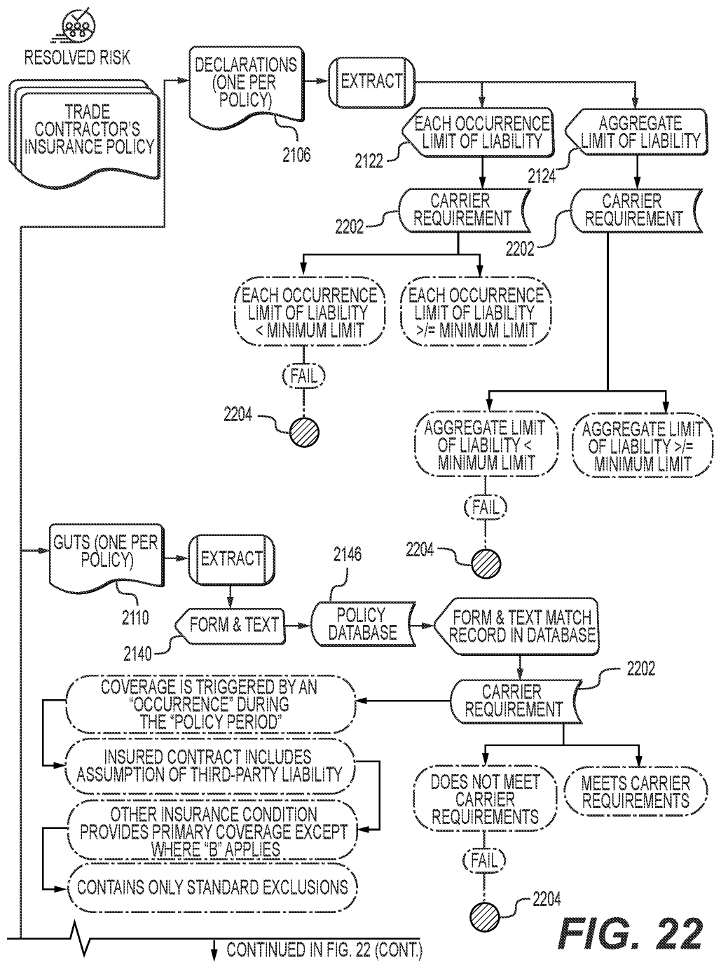

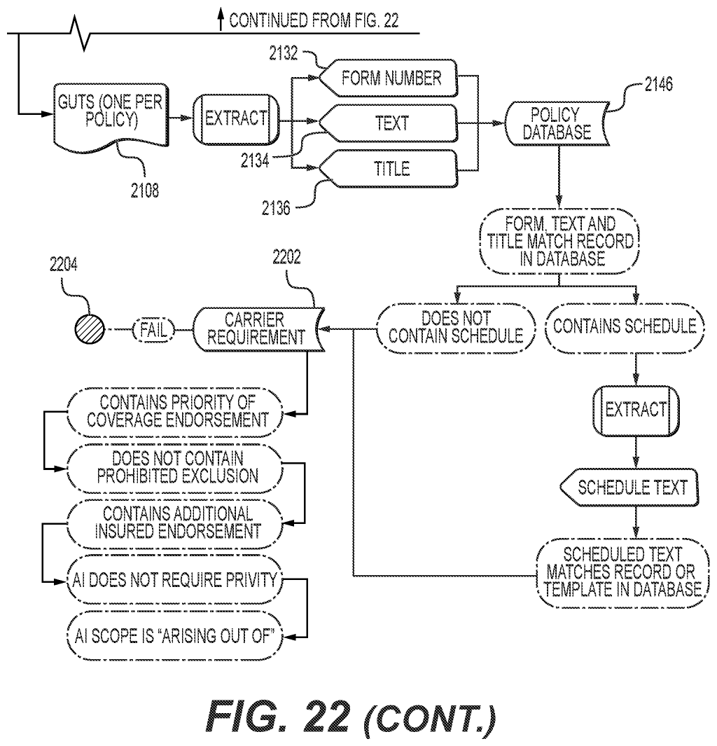

As further depicted in FIG. 22, the values extracted from these sections are compared against reference values derived from the policy database 2146 and/or table(s) containing user input data including client requirements 2202 defined in the template (minimum limits, maximum deductible/self-insured retention, required or prohibited provisions) and criteria defined by the client end user (job location, vendor name, job start-date, job-specific required or prohibited provisions, required additional insureds). The system returns results indicating compliance/non-compliance with the criteria specified in the user input data.

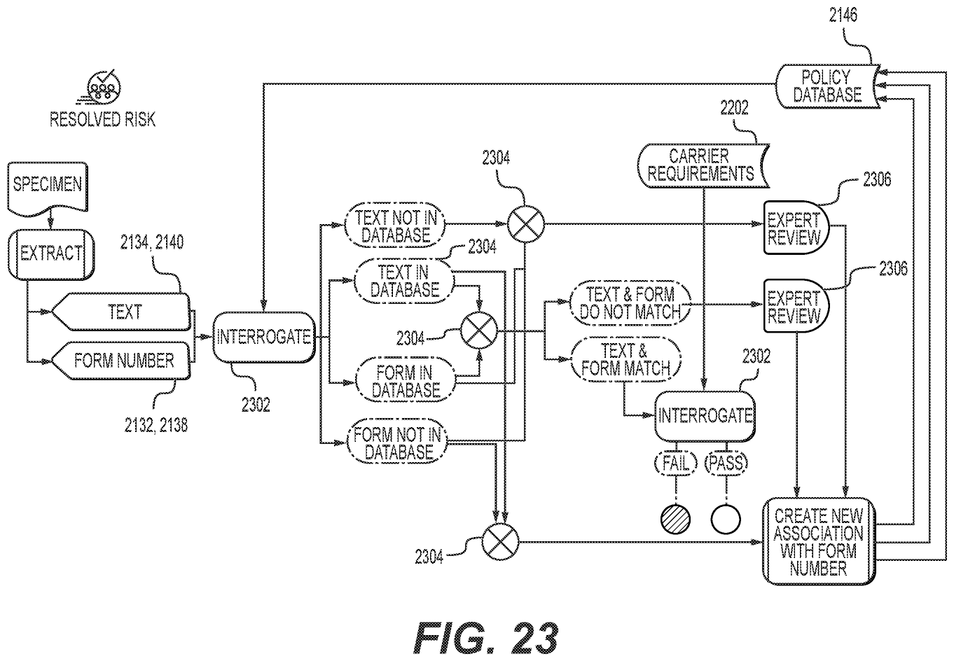

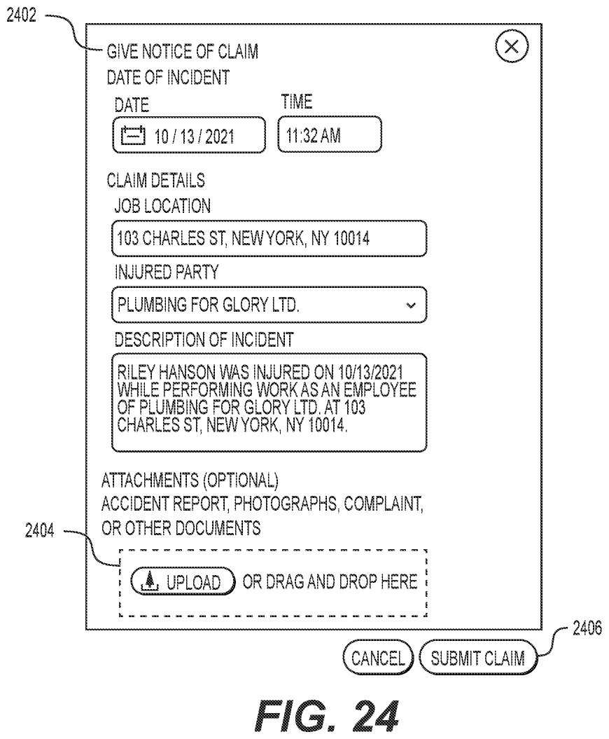

As further depicted in FIG. 23, sections identified as endorsements or coverage forms are compared against the reference library built by the labeler in interrogation step 2302. If an endorsement or coverage form has been labeled, the values extracted from the document are compared against the values contained in the database and/or table(s) of the labeler in steps 2304. If the endorsement or coverage form has not been labeled, it is sent to a queue for review by the human labeler in step 2306. The human labeler characterizes the item (as identified by form number and title) as generally “compliant” or “non-compliant” and then categorizes the item within a common schema of coverage criteria.

A master endorsement database contains forms that have been labeled using a human-M-ille-loop review process. In this process an expert reviews and labels Endorsements as compliant/non-compliant with predefined sets of risk transfer requirements 2202 stored in a client requirement database.

Submitting a Claim

A stakeholder authorized to view a job administered by the RR system can place the client for any vendor on notice of a claim or potential claim by selecting the give notice of claim button 2002 in FIG. 20. This causes a claim screen 2402 to be displayed in which the vendor or contractor can input the details of the incident. Information such as job location, injured party, and a description of the incident must be added. The injured party can be selected from any of the policyholders or a new one can be added. The claims screen 2402 also preferably comprises an attachment option 2404 for attaching accident reports, photographs, or other documents to substantiate the claim. Once all of the information has been added in claims screen 2402, the vendor can select submit claim selection 2406.

When a stakeholder clicks the claim selection 2406, a boilerplate communication is populated with data associated with the vendor policy and stored in the notice database. The vendor policy is parsed and a result is returned to the parser database as shown in FIG. 21. The data retrieved from the process may include ‘address for notice of claim,’ ‘client name,’ ‘policy period,’ ‘policy number’ and ‘named insured.’ This information is associated with the vendor policy and stored in the notice database.

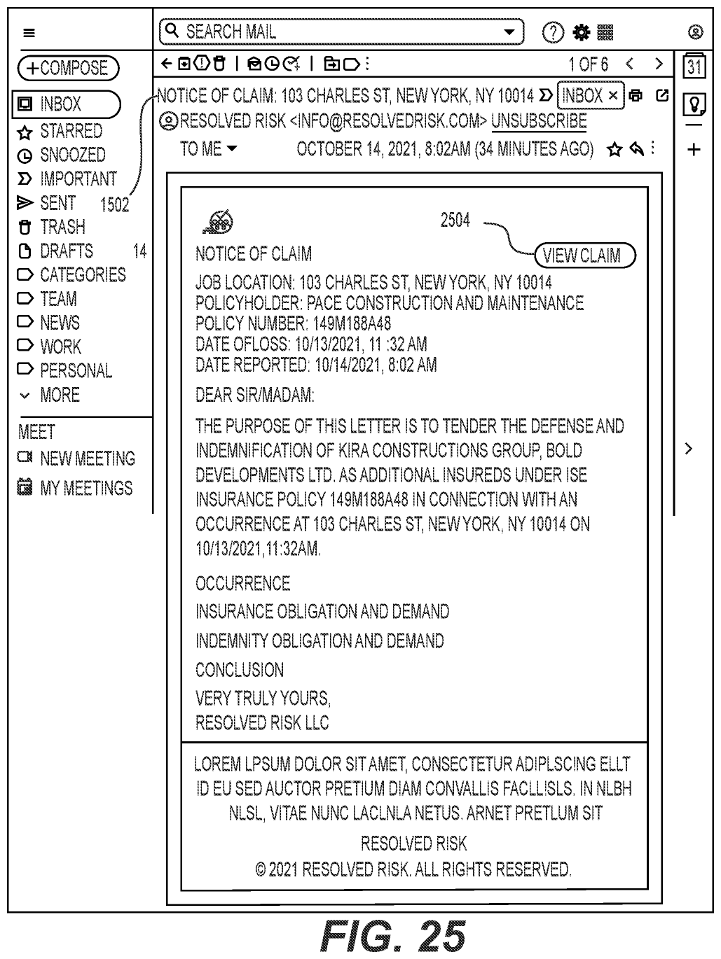

An email or letter is generated for transmission to the client at the address specified in the vendor policy. The email or letter includes, as an exhibit, the subcontract agreement between the vendor and the RR. Policyholder, which is created in the manner described below and stored in the contract database. As depicted in FIG. 25, the claim communication 2502 comprises a summary of the claim as well as a link 2504 that can be used to view additional details of the claim such as the attachments.

Onboarding Vendors

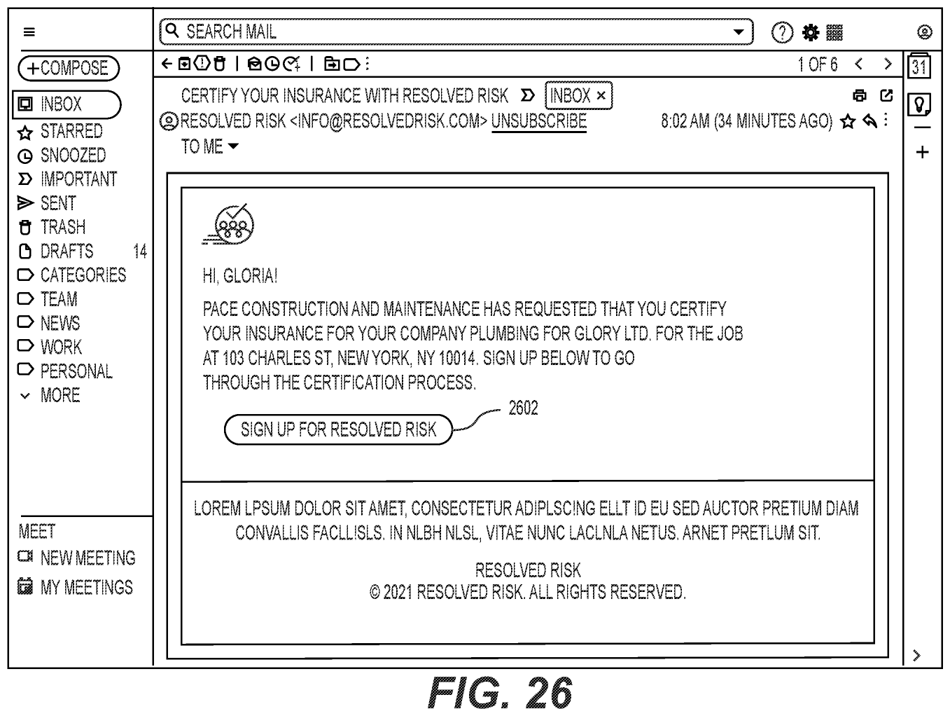

The present invention also comprises a method for the creation of contractual liability risk transfer obligations between a policyholder and a non-party vendor consistent with the liability risk transfer requirements specified in the insurance policy issued to the policyholder by the client. If a vendor is not already in the vendor database, the system may send an invite to the vendor inviting them to sign up as shown in FIG. 26. The vendor selects sign up selection 2602 to begin the sign up process.

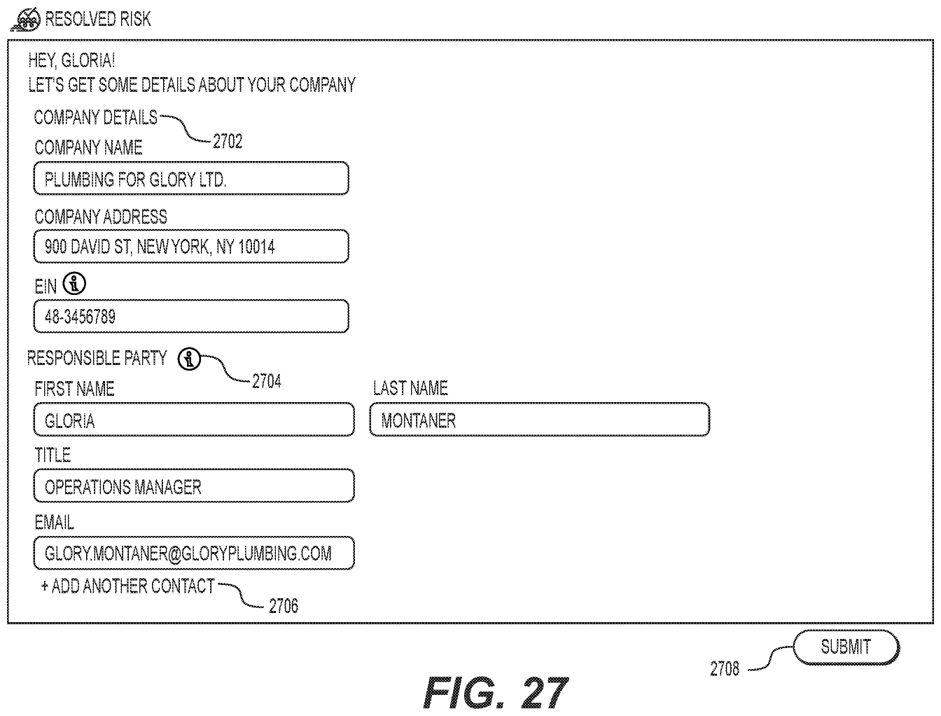

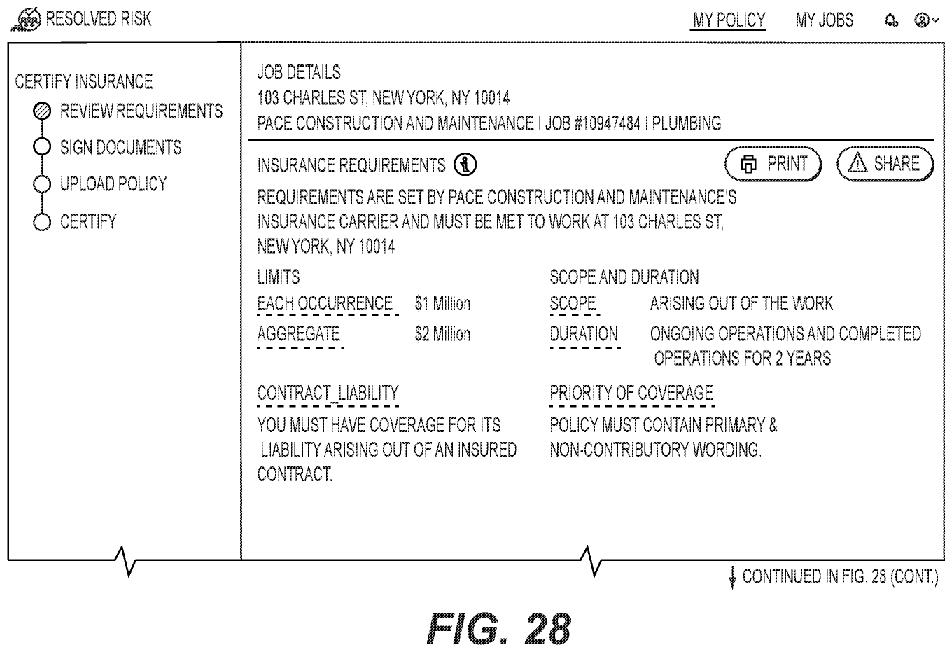

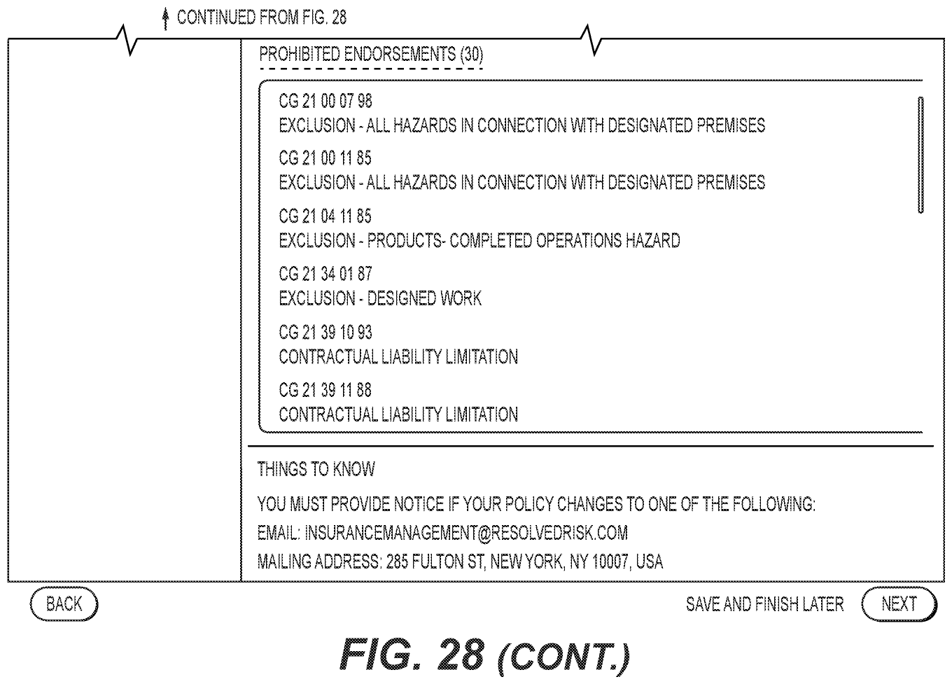

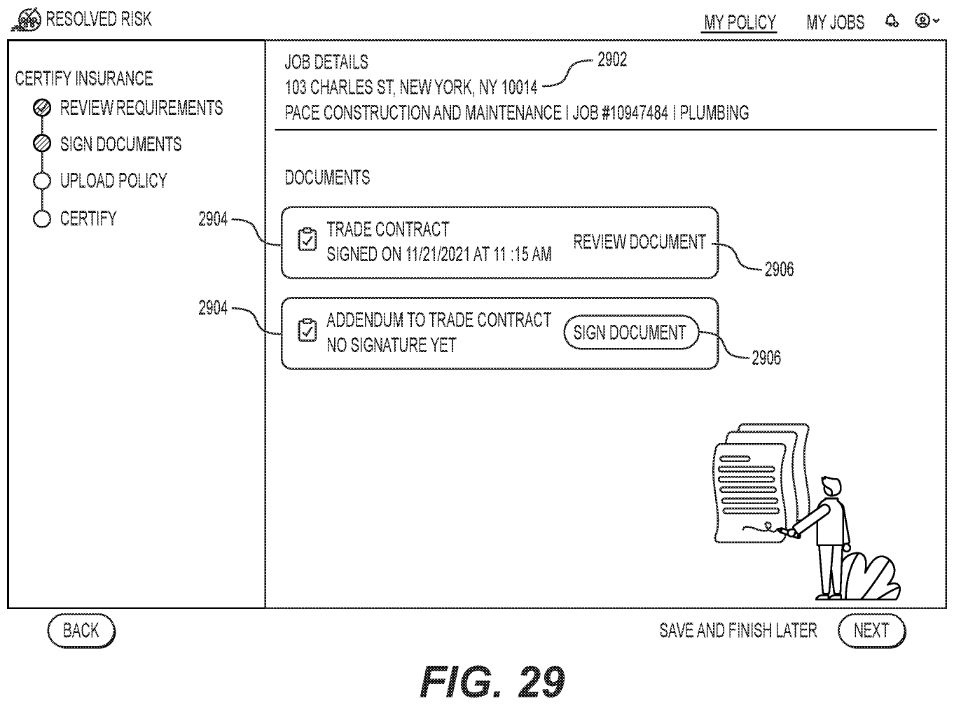

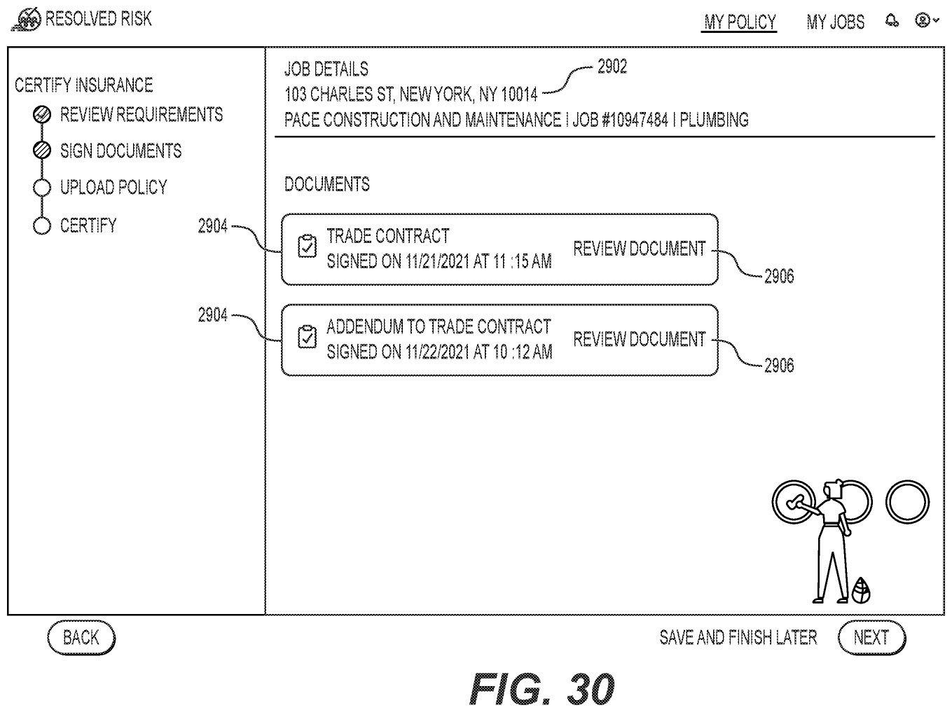

Once the vendor selects sign up selection 2602, they are directed to a sign up screen as depicted in FIG. 27. In some embodiments, some of the fields may be prepopulated if they were entered by the client or an administrator. The vendor first supplies company details 2702 and responsible party information 2704. Multiple responsible parties may be added by selecting add another contact selection 2706. The vendor then must click submit selection 2708 to proceed to the next screen.

A main feature of the present invention is the ability to certify insurance without the need to contact the insurance issuer, broker or agent to obtain a certificate of insurance. The insurance verification process begins after the vendor has signed up. A requirements screen 2802 first provides the new vendor with the insurance requirements for the vendor. For this particular vendor, the insurance requirements have utilized the Bronze requirements (see FIG. 6). The system will accept only vendors that have the specified insurance requirements.

After reviewing the insurance requirements, the vendor is next provided with documents screen 2902. This screen contains all documents that were uploaded when the job was created such as vendor contracts. Each document 2904 has an associated status selection 2906 informing the vendor what action needs to be taken for each document. For example, the vendor contract 2904 has a review document status selection 2906 that will provide the vendor with a copy of the vendor contract that was signed on Nov. 21, 2021. In contrast, the addendum to vendor contract 2904 has not yet been signed, so the status selection 2906 states “sign document.” if the vendor clicks on a sign document selection, they will be provided with the ability to sign the document electronically within the system or directed to a third-party signature service such as DocuSign or the like. Once the addendum to vendor contract 2904, the status selection 2906 is updated to review document as shown in 30.

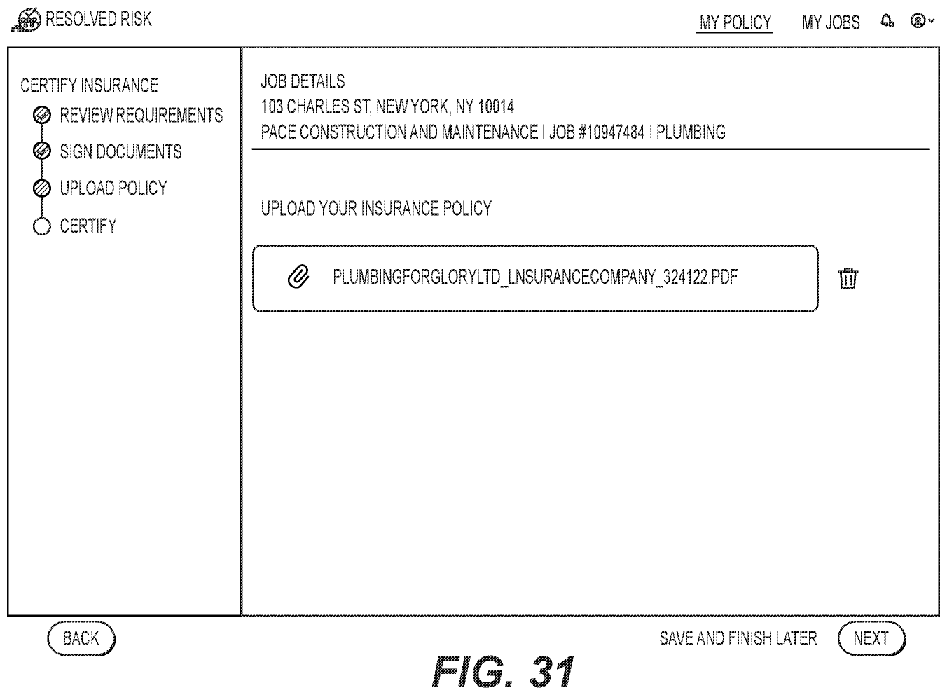

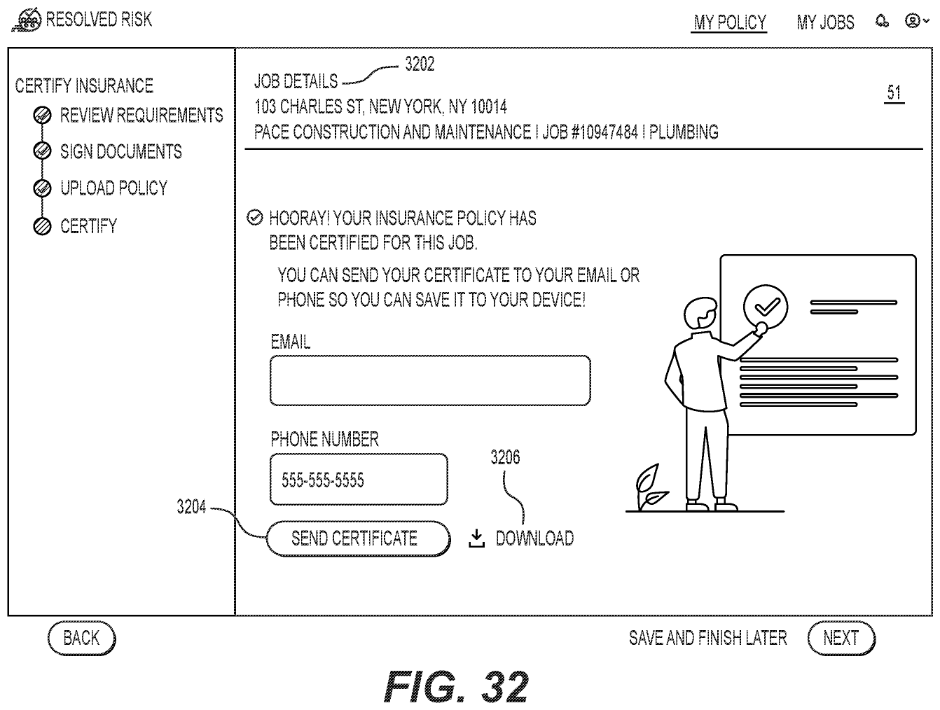

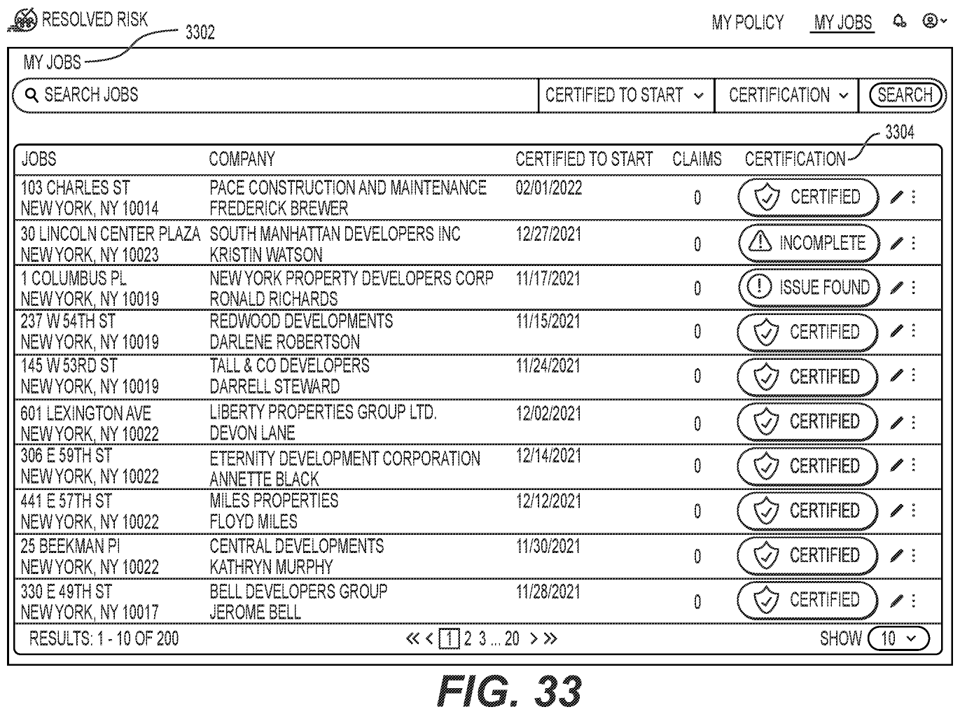

To verify that the vendor insurance meets the requirements specified in requirements screen 2802, the vendor is directed to upload a copy of their insurance policy in FIG. 31. Preferably the insurance policy is uploaded as a single document. The insurance policy is then parsed and analyzed to determine if all insurance requirements are met. The vendor will be informed if the insurance policy is certified, does not meet requirements, or is unreadable. If the insurance policy is unreadable, the vendor is provided another opportunity to resubmit the insurance policy. If the insurance policy is verified, the vendor is notified on certification screen 3202 and a certificate of insurance is automatically generated. The vendor can input an email or phone number and select the send certificate selection to transmit the certificate of insurance to any par ty. In addition, the vendor can choose the download selection to download a copy of the certificate of insurance verification (e.g., for printing or local storage).

Each vendor in the system has access to a Myjobs screen 3302 which lists all jobs for a particular vendor and the current certification status 3304 of the insurance policy for each job. Since different jobs have different requirements, the same insurance policy may be certified for certain jobs and not certified for other jobs with more stringent requirements.

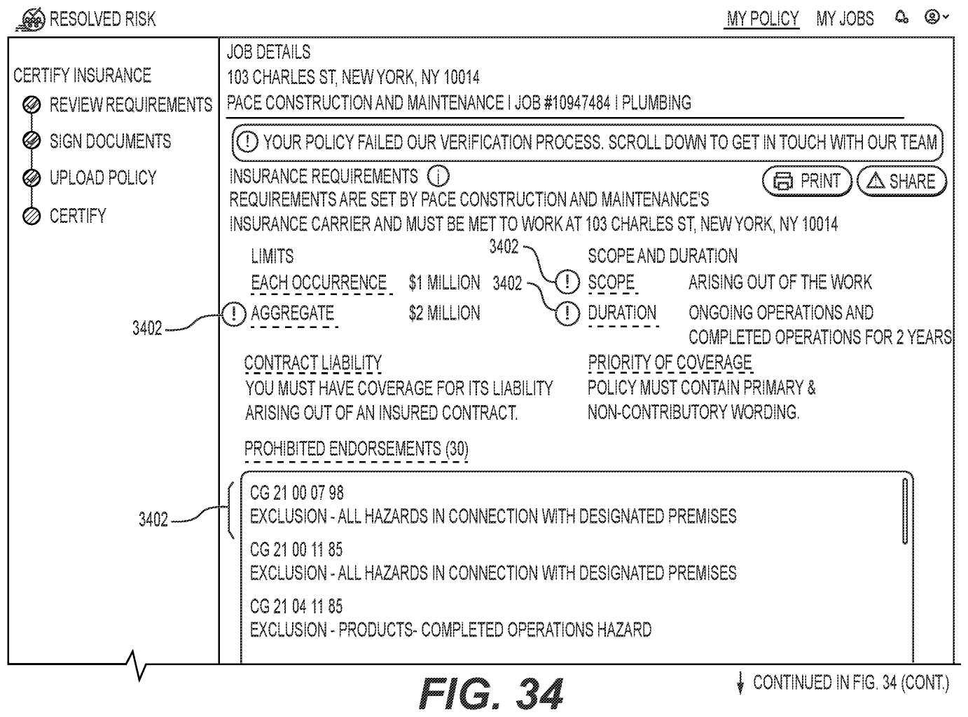

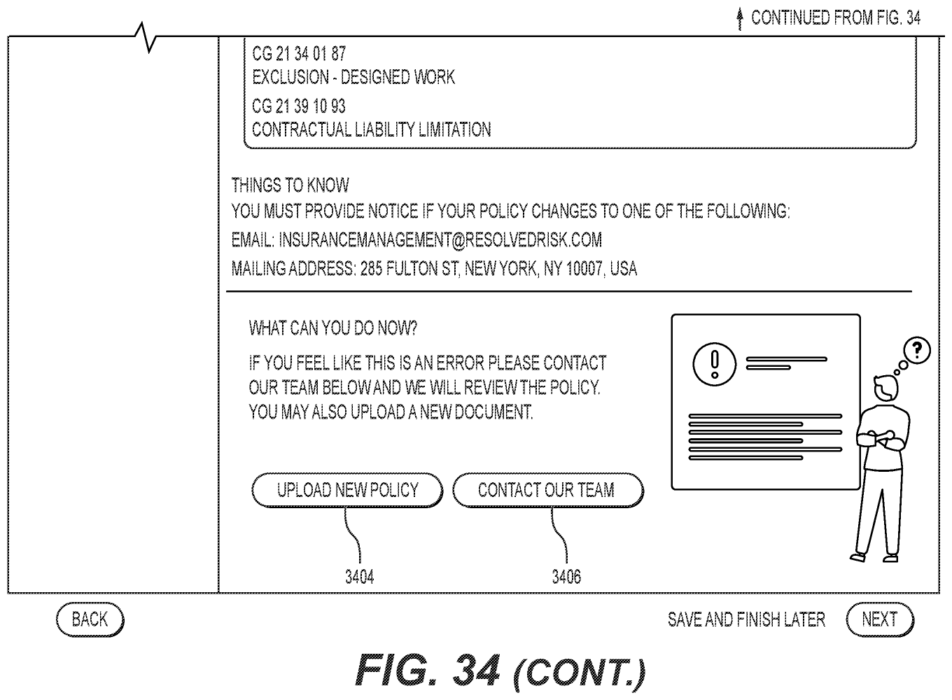

If the insurance policy fails the verification process, the vendor is informed which portions of the insurance policy were inadequate for the job as depicted in FIG. 34. A plurality of warning indicators 3402 are provided next to each of the insurance requirements that was not met by the insurance policy. For example, the insurance policy here has enough coverage for each incidence occurrence, but the aggregate is not high enough for this particular job. Also, the insurance policy lists two prohibited endorsements that are not allowed under the insurance requirements for this job.

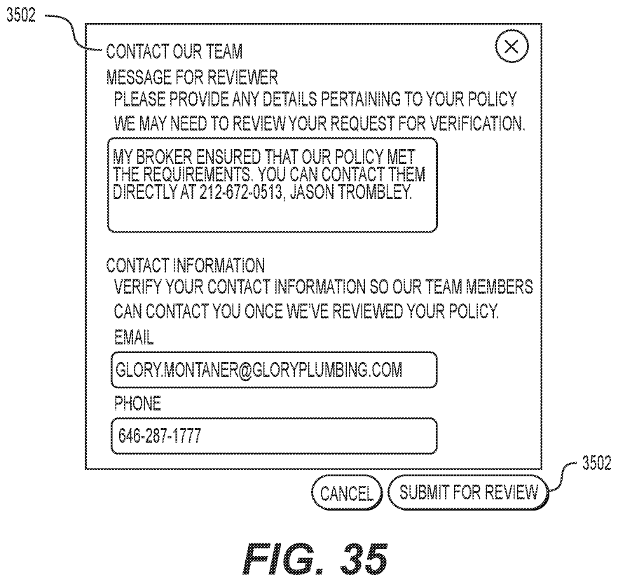

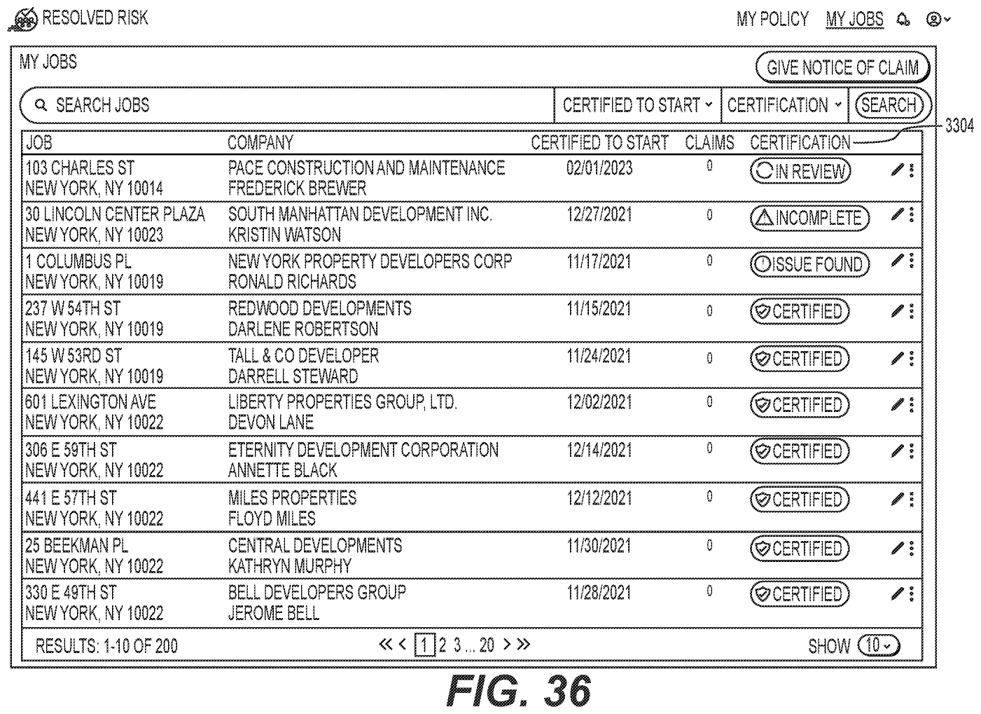

The vendor is provided with an option 3404 to upload a new or modified insurance policy (e.g., an addendum) or to contact an administrator (option 3406). If the vendor uploads a new policy, the new policy will then be analyzed for compliance and a similar screen to 34 will be displayed with the details of the new policy (if it is also not sufficient). If the vendor chooses option 3406 to contact an administrator, they can submit a contact form requesting review by the administrator as depicted in FIG. 35. The vendor may provide a message to the reviewer as well as contact information before selecting the submit for review option 3502. In some embodiments, the vendor may be provided with a communication that the insurance policy is being reviewed and/or approved after review. Selecting the submit for review option 3502 causes the status of the job to be updated to “in review” and eventually “certified” if the review is successful as depicted in FIG. 36.

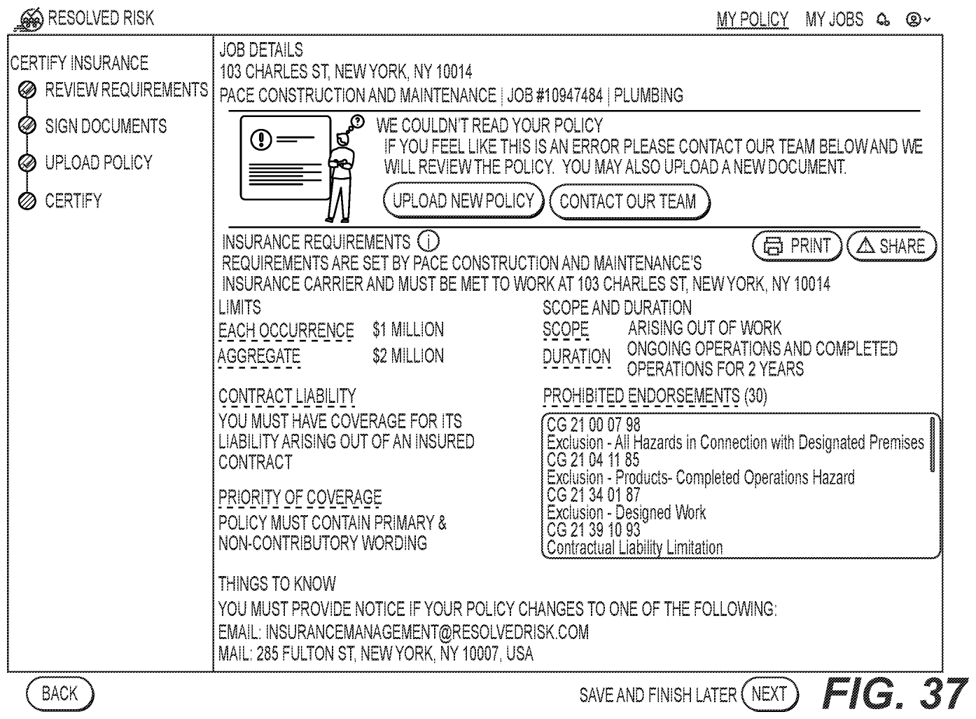

If the insurance policy is unreadable, the vendor will be provided with a screen similar to FIG. 37. The vendor is notified that the policy could not be read or parsed by the system. Like in FIG. 34, the user can choose to upload a new insurance policy or contact a reviewer.

1. A method for determining compliance with client requirements, comprising:
receiving a policy in a machine readable format from a vendor;
parsing the policy into a plurality of sections;
for each of the plurality a sections, extracting at least one section keyword;
comparing the at least one keyword from the plurality of sections to a corresponding entry in a set of client requirements to determine compliance with the client requirements; and
providing a result of the comparison to the vendor indicating which section keywords from the at least one section keywords did not meet the client requirements.

2. The method of claim 1, wherein the machine readable format is a portable document format (PDF).

3. The method of claim 1, wherein the plurality of sections are determined by comparing a title of a section from the plurality of sections to section titles to entries stored in a policy database.

4. The method of claim 1, wherein a first section of the plurality of sections is a declarations section and where a second section of the plurality of sections is an endorsements section.

5. The method of claim 4, wherein the at least one section keyword from the declaration section is a name of the insured.

6. The method of claim 5, wherein the name of the insured is utilized as an entry in a risk transfer agreement created from a boilerplate.

7. The method of claim 1, further comprising:
providing an error message to the vendor if a portion of the policy cannot be parsed.

8. The method of claim 1, wherein the at least one section keyword is a policy period, a limit on each occurrence of liability, or an aggregate limit of liability.
